(19) United States
(12) Patent Application Publication
(10) Pub. No.: US 2026/0116761 A1
(43) Pub. Date: Apr. 30, 2026

(54) A METHOD OF EDGE-FUNCTIONALISING A 2D MATERIAL

(71) Applicant: National University of Singapore, Singapore (SG)

(72) Inventors: Antonio Helio de CASTRO NETO, Singapore (SG); Katarzyna Joanna ZAWADA DONATO, Singapore (SG); Ricardo KEITEL DONATO, Singapore (SG); Kok Wai Gavin KOON, Singapore (SG); Jiale Sarah LEE, Singapore (SG)

(21) Appl. No.: 19/120,576

(22) PCT Filed: Oct. 19, 2022
(86) PCT No.: PCT/SG2022/050742

§ 371 Date: Apr. 11, 2025

(51) Int. Cl. C01B 32/194; C09D 1/00; C09D 5/24; C09D 7/62

(52) U.S. Cl. CPC C01B 32/194; C09D 1/00; C09D 5/24; C09D 7/62; C01B 2204/04; C01B 2204/22; C01P 2002/82; C01P 2002/84; C01P 2006/40

(57) ABSTRACT

There is provided a method of forming an edge-functionalised 2D material, comprising mixing the 2D material with a solvent at a first pre-determined temperature, adding an oxidising agent and a multifunctional molecule, adjusting the temperature to a second pre-determined temperature, adjusting the temperature to a third pre-determined temperature and adding a quenching agent to form a suspension, wherein the suspension comprises the edge-functionalised 2D material.

### TECHNICAL FIELD

The present invention relates to a method of functionalising two-dimensional (2D) materials, in particular, forming an edge-functionalised 2D material.

### BACKGROUND

One of the most important characteristics of two-dimensional (2D) materials is that they are pure surfaces, namely, they have two sides but no three-dimensional (3D) bulk. Therefore, it is possible to use surface functionalization techniques to change their physical and chemical properties creating an enormous number of possibilities in terms of structures and functionalities. For example, graphene, the most commonly known 2D material, which in its pure form is hydrophobic, can be functionalized by oxidation to produce graphene oxide (GO), thereby becoming hydrophilic. Surface functionalization of 2D materials therefore became a very effective method to tailor properties of 2D materials. However, the process of functionalization is random in nature. Extrinsic atoms and molecules used in functionalization attach themselves to the imperfections in the basal plane of 2D materials such as vacancies, sp³ defects, etc., because the energy barriers for chemical reaction is lower, thereby introducing a large degree of disorder. As an example, graphene is an electrical and thermal conductor while GO is a highly disordered electric and thermal insulator. Hence, introduction of disorder in the basal plane of 2D materials impacts many of the desirable properties of the original 2D material.

There is therefore a need for an improved method of functionalising 2D materials.

### SUMMARY OF THE INVENTION

The present invention seeks to address these problems, and/or to provide an improved method of functionalising 2D materials.

According to a first aspect, the present invention provides a method of forming an edge-functionalised 2D material, the method comprising:
mixing a 2D material with a solvent at a first pre-determined temperature to form a dispersion;
adding an oxidising agent and a multifunctional molecule to the dispersion;
adjusting the temperature to a second pre-determined temperature for a pre-determined period of time;
adjusting the temperature to a third pre-determined temperature; and
adding a quenching agent to form a suspension, wherein the suspension comprises the edge-functionalised 2D material.

The solvent may be any suitable solvent. For example, the solvent may be, but not limited to an oxidising acid.

The mixing may be carried out under suitable conditions. For example, the mixing may be carried out at a first pre-determined temperature, which may be any suitable temperature. For example, the first pre-determined temperature may be ≤10° C.

The mixing may comprise mixing a suitable amount of solvent and 2D material. According to a particular aspect, the mixing comprises mixing the solvent and the 2D material in a weight ratio of 8:1-28:1.

The adding an oxidising agent and a multifunctional molecule may comprise adding any suitable oxidising agent and multifunctional molecule, respectively. For example, the multifunctional molecule may comprise, but is not limited to, a multifunctional alcohol, multifunctional amine, amino alcohol, thiol, or a mixture thereof.

According to a particular aspect, the adding an oxidising agent and a multifunctional molecule to the dispersion may comprise adding the oxidising agent and multifunctional molecule sequentially. In particular, the oxidising agent may be added to the dispersion first, followed by adding the multifunctional molecule. Even more in particular, the multifunctional molecule may be added to the dispersion after a period of time following the adding of the oxidising agent. For example, the period of time may be any suitable period of time. According to a particular aspect, the period of time may be 1-15 minutes.

The adjusting the temperature to a second pre-determined temperature may comprise adjusting the temperature to any suitable temperature. For example, the second pre-determined temperature may be ≤25° C.

The adjusting the temperature to a second pre-determined temperature may comprise maintaining the temperature at a second pre-determined temperature for any suitable period of time. For example, the pre-determined period of time may be ≤60 minutes.

The adjusting the temperature to a third pre-determined temperature may comprise adjusting the temperature to any suitable temperature. For example, the third pre-determined temperature may be ≤10° C.

The adding a quenching agent may comprise adding any suitable quenching agent. For example, the quenching agent may be, but not limited to, a reducing agent for quenching oxidation and functionalisation of the 2D material.

The method may further comprise separating a precipitate from the suspension formed following the adding a quenching agent, wherein the precipitate comprises the edge-functionalised 2D material. The separating may be by any suitable method.

According to a further aspect, the formed edge-functionalised 2D material may be formed into a film.

### BRIEF DESCRIPTION OF THE DRAWINGS

In order that the invention may be fully understood and readily put into practical effect there shall now be described by way of non-limitative example only exemplary embodiments, the description being with reference to the accompanying illustrative drawings. In the drawings:

FIG. 1 shows a schematic representation of a set-up for the method according to one embodiment of the present invention;

FIG. 2 shows the Raman spectra of the different distributions of intensity on a basal plane and edges of an edge-functionalised graphene material;

FIG. 3 shows the UV-Vis of an edge-functionalised graphene material;

FIG. 4 shows the Raman spectroscopy showing averaged and normalised intensities of the D, G and 2D bands of an edge-functionalised graphene material, with graphene results included as reference;

FIG. 5 shows a schematic representation of a set-up for the method according to one embodiment of the present invention; and

FIG. 6 shows a schematic representation of a method for obtaining a highly ordered film formation using an edge-functionalised 2D material formed according to one embodiment of the present invention.

### DETAILED DESCRIPTION

As explained above, there is a need for an improved method of functionalising 2D materials.

In general terms, the invention relates to an improved and controlled method of functionalising 2D materials such that there is minimal effect on the 2D basal plane. The edge of a 2D material is a one-dimensional (1D) structure. By functionalizing the 1D edges, the electronic and structural properties of the basal plane may be preserved and at the same time, the macroscopic properties of the 2D material may be modified. Further, the method is based on mild and selective modification of 2D materials, thereby making the method reproducible as well as environmentally friendly compared to prior art methods.

According to a first aspect, the present invention provides a method of forming an edge-functionalised 2D material, the method comprising:
mixing a 2D material with a solvent at a first pre-determined temperature to form a dispersion;
adding an oxidising agent and a multifunctional molecule to the dispersion;
adjusting the temperature to a second pre-determined temperature for a pre-determined period of time;
adjusting the temperature to a third pre-determined temperature; and
adding a quenching agent to form a suspension, wherein the suspension comprises the edge-functionalised 2D material.

The 2D material may be any suitable 2D material. For example, the 2D material may be, but not limited to, graphene, graphyne, graphane, borophene, boron nitride, germanene, silicene, stanine, plumbene, antimonene, bismuthine, phosporene, transition metal dichalcogenides, MXenes such as transition metal carbides, nitrides, carbonitrides, or a combination thereof. According to a particular aspect, the 2D material may be graphene, boron nitride, or a combination thereof.

The solvent may be any suitable solvent. The solvent may be an acid, preferably a mineral acid. According to a particular aspect, the solvent may be, but not limited to an oxidising acid. For example, the solvent may be, but not limited to: sulphuric acid, nitric acid, phosphoric acid, perchloric acid, iodic acid, chromic acid, or a mixture thereof.

Suitable amounts of the solvent and the 2D material may be mixed during the mixing. According to a particular aspect, the mixing may comprise mixing the solvent and the 2D material in a weight ratio of 8:1-28:1. For example, the weight ratio of the solvent to the 2D material may be 10:1-25:1, 12:1-20:1, 13:1-19:1, 15:1-18:1, 16:1-17:1. Even more in particular, the weight ratio of the solvent to the 2D material may be 12:1-14:1.

The mixing may be carried out under suitable conditions. For example, the mixing may be carried out at a first pre-determined temperature, which may be any suitable temperature. According to a particular aspect, the first pre-determined temperature may be ≤10° C. In particular, the first pre-determined temperature may be 1-10° C., 2-9° C., 3-8° C., 4-7° C., 5-6° C. Even more in particular, the first pre-determined temperature may be 1-10° C.

The adding an oxidising agent and a multifunctional molecule may comprise adding any suitable oxidising agent and multifunctional molecule, respectively. For example, the multifunctional molecule may comprise any suitable multifunctional molecule based on the desired functionalisation of the 2D material. According to a particular aspect, the multifunctional molecule may be, a multifunctional molecule comprising terminal functional groups based on oxygen, nitrogen, sulphur, phosphorus, boron and/or silicon. In particular, the multifunctional molecule may be, but is not limited to, a multifunctional alcohol, multifunctional amine, amino alcohol, thiol, or a mixture thereof. For example, when the multifunctional molecule is water, functional groups such as —OH— and —O— may be yielded, while when the multifunctional molecule is a diamine or dialcohol, the functional group may be —RNH₂ or —ROH, respectively. Further examples include, but are not limited to, dialcohols, ethylene glycol, triethylene glycol, glycerol, erytrytol, diamines, ethylene diamine, diethylenetriamine, triethylenetetamine, triethyleneglycol diamine, diaminodiphenylmethane, melamine, leucinol, valinol, alaninol, cysteine, thioalanine, or a mixture thereof.

The adding an oxidising agent and a multifunctional molecule to the dispersion may comprise adding the oxidising agent and multifunctional molecule simultaneously or sequentially. According to a particular aspect, the adding an oxidising agent and a multifunctional molecule to the dispersion may comprise adding the oxidising agent and multifunctional molecule sequentially. In particular, the oxidising agent may be added to the dispersion first, followed by adding the multifunctional molecule. The multifunctional molecule may be added to the dispersion after a period of time following the adding of the oxidising agent. The period of time may be any suitable period of time. For example, the period of time may be after the oxidising agent may have dissolved into the dispersion to form a homogeneous solution. According to a particular aspect, the period of time may be ≤15 minutes. For example, the period of time may be 1-15 minutes. In particular, the period of time may be 1-12 minutes, 2-10 minutes, 3-9 minutes, 4-8 minutes, 5-7 minutes.

According to a particular aspect, the temperature of the dispersion during the adding an oxidising agent and a multifunctional molecule may be maintained at the first pre-determined temperature. In particular, the temperature of the dispersion may be maintained at a temperature of ≤10° C. In particular, the temperature may be maintained at a temperature of 1-10° C., 2-9° C., 3-8° C., 4-7° C., 5-6° C. Even more in particular, the temperature may be maintained at 5-10° C. Following the addition of the oxidising agent, radical formation may begin. However, as the temperature during the radical formation is kept low, there is decreased intercalation associated with decreased radical reactivity. At the same time, the increased reactivity at the 2D material's edges as compared to the basal plane, the functionalisation of the edges of the 2D material is greatly favoured.

Following the addition of the oxidising agent and the multifunctional molecule, the temperature may be adjusted to a second pre-determined temperature. The adjusting the temperature to a second pre-determined temperature may comprise adjusting the temperature to any suitable temperature. For example, the second pre-determined temperature may be the same as the first pre-determined temperature or a temperature ≤25° C. In particular, the second pre-determined temperature may be 1-25° C., 10-23° C., 12-22° C., 15-20° C., 17-18° C. Even more in particular, the second pre-determined temperature may be 10-25° C.

The adjusting may comprise adjusting the temperature to a second pre-determined temperature by any suitable means. For example, the adjusting may comprise not providing any cooling and therefore allowing temperature to increase naturally. Alternatively, external heating means may be provided. Regardless of the heating means, the heat rate may be any suitable heat rate. For example, the heat rate may be a heat rate of 2-4° C./minute.

The adjusting the temperature to a second pre-determined temperature may comprise maintaining the temperature unaltered, or at a second pre-determined temperature for any suitable period of time. For example, the pre-determined period of time may be ≤60 minutes. In particular, the pre-determined period of time may be 5-60 minutes, 7-58 minutes, 10-55 minutes, 15-50 minutes, 20-45 minutes, 25-40 minutes, 30-35 minutes. Even more in particular, the pre-determined period of time may be 20-60 minutes.

The adjusting the temperature to a third pre-determined temperature may comprise adjusting the temperature to any suitable temperature. According to a particular aspect, the adjusting the temperature to a third pre-determined temperature may comprise adjusting the temperature to a lower temperature as compared to the second pre-determined temperature. In particular, the third pre-determined temperature may be ≤10° C. In particular, the third pre-determined temperature may be 1-10° C., 2-9° C., 3-8° C., 4-7° C., 5-6° C. Even more in particular, the third pre-determined temperature may be 5-10° C.

The oxidation and functionalisation of the 2D material may be halted by adding a quenching agent. Accordingly, the adding a quenching agent may comprise adding any suitable quenching agent. For example, the quenching agent may be, but not limited to, a reducing agent for quenching oxidation and functionalisation of the 2D material. In particular, the quenching agent may be an inorganic reductant. For example, the quenching agent may be, but not limited, hydrogen peroxide, sodium hyposulfite, hydroxylamine hydrochloride and sodium sulfite, or a mixture thereof.

The adding a quenching agent may comprise adding any suitable amount of the quenching agent. For example, the amount of quenching agent added may depend on the amount of oxidising agent added in the adding an oxidising agent and a multifunctional molecule to the dispersion. In particular, the weight ratio of oxidising agent to quenching agent may be 1:2, 1:1.8, 1:1.6, 1:1.5. For example, the weight ratio may be 1:1.6.

The method may further comprise separating a precipitate from the suspension formed following the adding a quenching agent, wherein the precipitate comprises the edge-functionalised 2D material. The separating may be by any suitable method. For example, the separating may be by transferring the suspension through a separating funnel to separate the precipitated slurry from the suspension.

The method may further comprise cleaning and/or washing the precipitate. The cleaning and/or washing may be by using any suitable solvent. For example, the cleaning and/or washing may be by using, but not limited to, water, HCL, ethanol, or a mixture thereof.

According to a further aspect, the formed edge-functionalised 2D material may be formed into a film. The film may be formed by simple methods at room temperature and may not require any further post-treatment such as thermal or chemical modification. Since the edge-functionalised 2D material may be partially organized intrinsically, less overall energy may be required to obtain organised films and bulky material. In particular, solvent dispersions of the edge-functionalised 2D material may be filtered or casted, forming highly organised films with high anisotropic conductivity and of sufficient mechanical strength to form free-standing films.

The film may be a free-standing film having properties such as smooth surface with low surface roughness. In particular, the film may have a surface roughness of ≤1 μm. For example, the surface roughness may be about 5-950 nm, 10-900 nm, 20-800 nm, 30-700 nm, 50-600 nm, 75-500 nm, 100-400 nm, 200-300 nm. The film may comprise a well oriented in-plane film with a dense cross-section profile. In particular, the cross-section of the film formed may have a thickness of ≤5 mm. In particular, the thickness may be 3-400 μm, 5-250 μm, 10-200 μm, 50-150 μm, 75-100 μm.

The method described above is a simple method for selectively functionalising a 2D material. In particular, the method is a mild yet selective method of modifying 2D materials in which the 1D edges are considerably more functionalised as compared to the 2D basal plane. Even more in particular, most of the original conductive properties of the 2D material may be conserved even after being edge-functionalised since the 2D basal plane is conserved. Since the conductive properties are anisotropic, the creation of films that are highly electrically and thermally conductive in-plane but not out-of-plane may be achieved.

Further, the method described above is a relatively fast method in which the selective functionalisation reaction may be achieved in less than or equal to about 2 hours.

Another advantage of the method is that the functionalised 2D materials are stable in water and other polar solvents and solvent mixtures without losing the functionalised properties. In this way, the functionalised 2D materials may be stored as high viscosity liquids or as highly concentrated pastes which may be easily dispersed in water and other solvents, without the need for harsh methods such as ultrasonication.

As compared to traditional functionalization processes which use excess amounts of strong acids and oxidizing agents that lead to a substantial amount of chemical waste, the method described above is much more environmentally friendly and sustainable since a much lesser quantity of materials is required for the method described above. Further, the method of edge functionalization is based on the mild and selective modification of 2D materials via an extreme adaptation of standard chemical oxidation methods, by exploiting the higher reactivity of the 2D materials and its regioselective reactivity (1D edges vs. 2D basal plane).

As an example, both graphene and graphene oxide (GO) can be obtained from the same raw material (graphite), but following different processing pathways. One 2D material is an excellent thermal and electrical conductor (graphene) and the other is an insulator (GO). Thus, forming graphene films would be the logical path for obtaining conductive films, but forming films directly from graphene is challenging due to its low solubility and its strong tendency to aggregate. The most common approach to circumvent these issues is to initially prepare GO and further chemically reduce it to create reduced graphene oxide (rGO). The drawbacks of following this process route are:
long and costly process that produces large amounts of chemical residues;
rGO is very defective when compared to graphene, demanding harsh annealing and graphitization processes (high temperature) to partially fix the structural defects;
reduction, annealing and graphitization have to be performed on the final desired product (e.g., a GO film), and all these transformations unavoidably imprint porosity to the material (e.g., from gas release), which decreases the material's density and its overall electrical and thermal conductivity; and
the high temperatures demanded for annealing and graphitization, generally above 1000° C., dramatically limit their application, since very few substrates of target materials can handle these post-treatment temperatures.

Thus, in the method described above, a well-controlled modification that allows increasing the 2D material's processability without dramatically damaging the 2D material sheets and consequently not affecting its original properties. Moreover, since the functionalization produces a higher concentration of functional groups at the edge of the 2D material, the ordered interaction among sheets is increased, thereby increasing film formation properties. Consequently, this approach avoids the harsh post-treatments and vastly increases the range of applications for 2D films and other architectures.

Further, a much high reaction yield may be reached, for example, values of up to 30 g of product per litre of reactor (i.e., a 100 L reactor can produce 3 kg of product per batch with a batch cycle as short as 2 hours). Moreover, due to the accelerated nature of the method, they can be easily adapted to flow reactors without large process modifications, increasing further the reaction yield as a function of time. After the functionalization reaction, very different products may be obtained, such as but not limited to, water stable dispersion, highly concentrated and re-dispersible slurries, extruded or compressed films, pastilles and filaments, free-standing films and films deposited in complex texturized surfaces.

Altogether, there is provided a method for functionalisation of 2D materials, producing a dramatic improvement in their solubility/dispersibility in water and other polar solvents without losing most of the 2D basal plane pristine properties. As a consequence, this class of materials allows the preparation of highly ordered films and other bulk structures that conserve in good part of the 2D materials properties, including extremely high anisotropic properties, even on texturized surfaces and confined geometries. Such structures are relevant for a great variety of applications, including, but not limited to, thermal management, smart electronic devices, e-textiles, flexible and wearable electronics, sensors, membranes for filtration, batteries and supercapacitors.

Having now generally described the invention, the same will be more readily understood through reference to the following embodiment which is provided by way of illustration, and is not intended to be limiting.

### EXAMPLES

### Example 1—Functionalisation of Graphene Using Water as the Multifunctional Molecule

The method was performed using defined steps and a semi-automated setup to ensure reproducibility and reduce human intervention. A schematic representation of the setup is as shown in FIG. 1.

Concentrated sulfuric acid (95-98%) was initially added to a reactor and cooled down to 5° C. under constant stirring. In sequence, graphene (or micronized graphite) was added to the sulfuric acid, where the ratio graphene/acid defined the final level of oxidation/functionalization. The maximum concentration supported (due to viscosity restrictions), yielding the mildest oxidation, was 210 mg of graphene per 1 mL of sulfuric acid.

After stirring, until complete dispersion, forming a black viscous liquid (about 5-10 min), a 5% KMnO₄ aqueous solution was slowly added using a peristaltic pump, keeping the temperature constant at 5-10° C. This process took up to 1 h, depending on the reaction volume and flow applied, where the total amount of KMnO₄ was set to 133 mg/ml of sulfuric acid. At this stage the formation of ·OH and ·O· radicals took place, but reactivity of the radicals was kept lower due to the low temperature. After KMnO₄ addition, the temperature was increased to 22° C. for 20 min (oxidation/functionalization stage) and once again cooled down to 5° C. Water and a 32% H₂O₂ solution were added to quench the reaction and consume the excess of KMnO₄.

The simple fact of replacing graphite with graphene eliminated (or dramatically reduced) the sulfate intercalation process, avoiding confinement of acid and oxidant within the graphitic galleries and decreasing the availability of these reactants to modify (and damage) the basal plane. Moreover, since the temperature was kept low during the radical formation period, the decreased intercalation associated with decreased radical reactivity and with the increased reactivity at the graphene's edges (in relation to the basal plane) greatly favoured the functionalization at the graphene's edges, as seen in FIG. 2. In particular, FIG. 2 shows the reduced defects at the 2D basal plane.

After the reaction, the resulting suspension was kept at 5° C., diluted (2 ml of H₂O per 1 mL of sulfuric acid), quenched with a 35% H₂O₂ solution (0.06 ml H₂O₂ per 1 mL 5% KMnO⁴), and left stirring for 2 hours. The resulting suspension was transferred to a separation funnel and left overnight to precipitate. The precipitated slurry was then separated and cleaned with 2 cycles of washing using 10% HCl (7 mL of HCl per 1 mL sulfuric acid).

The resulting materials were stable in water and other polar solvents, allowing highly concentrated dispersions with concentrations as high as 10 mg/ml in water and 20 mg/mL in water/isopropanol mixtures (showing no precipitation for at least 24 hours). However, their physicochemical fingerprint resembles more graphene, showing very high carbon content (up to 90% C, and ˜95% of it being sp² carbon) and a low C/O ratio (˜10, but can be tuned depending on the desired property), as seen by X-ray photoemission spectroscopy (XPS) and elemental analysis. They also present high thermal stability as seen in thermogravimetric analysis (TGA), with the absence of the intercalation peak that refers to oxygen species in the basal plane as seen by X-ray diffraction analysis (XRD).

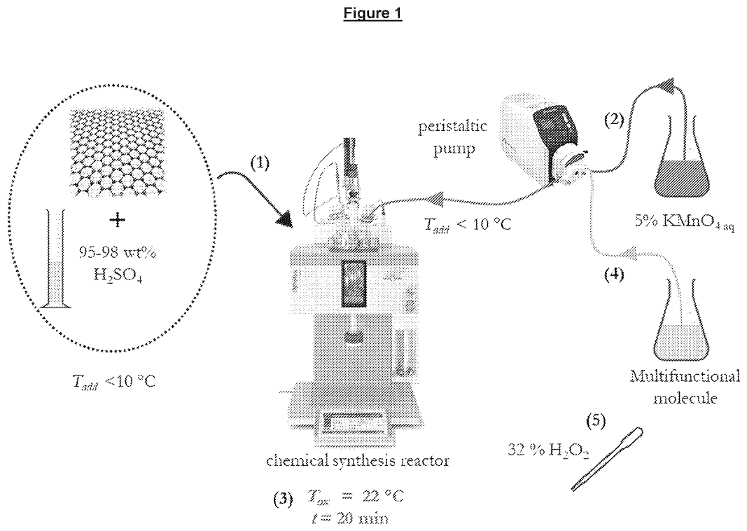

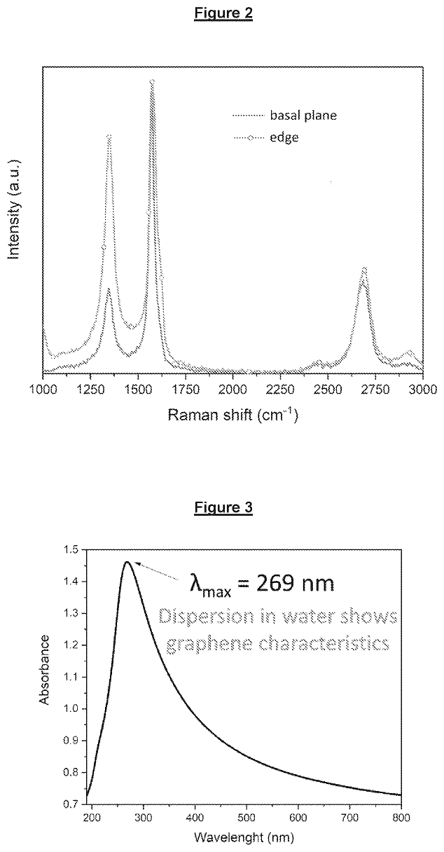

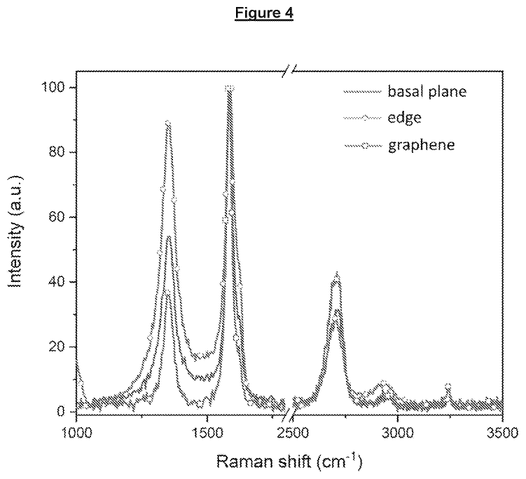

Most interestingly, they form stable dispersions in water that allow liquid phase ultraviolet-visible spectroscopy (UV-Vis) characterization and present an absorbance band atλ_{Amax}=269 nm as seen in FIG. 3, which is characteristic of graphene. Finally, also, in contrast to GO and graphene, they present a defined variation in Raman spectroscopy profile in different sheet regions, with defects located only at the edges as can be seen in FIG. 4.

### Example 2—Functionalisation of Graphene Using Heteroatomic Molecule as the Multifunctional Molecule

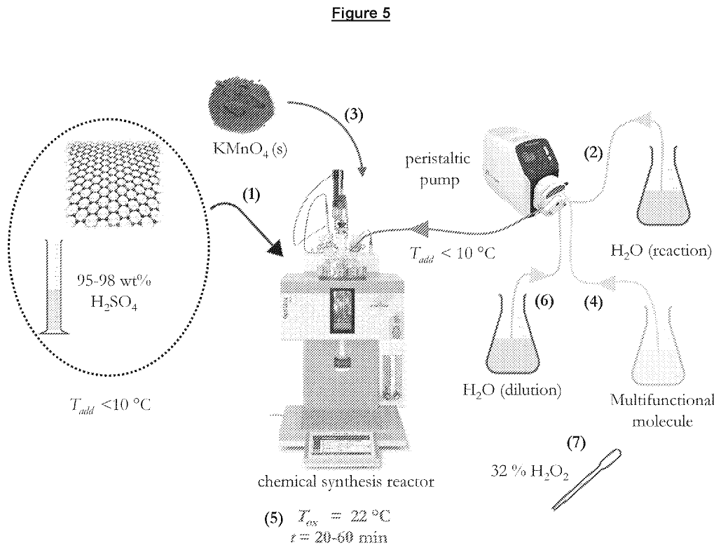

In analogy to the process of Example 1, the present Example provides a method of functionalising graphene using heteroatomic molecule as the multifunctional molecule instead of water. A schematic representation of the method is shown in FIG. 5.

Concentrated sulfuric acid (95-98%) was initially added to a reactor and cooled down to 5° C. under constant stirring. Graphene was added in the appropriate ratio for the desired functionalization level (Step 1, FIG. 5). After stirring, until complete graphene dispersion, forming a black viscous liquid (about 5-10 min), water was added to the reactor to slightly reduce the viscosity and later react to KMnO₄ forming O₃ that further induced radical formation (Step 2, FIG. 5). The amount of water was fixed to the amount of functionalizing molecule added in a molar ratio of 3:1 (water:multifunctional molecule). Then, grinded solid KMnO₄ was slowly added using the reactors' solid dosing unit, keeping the temperature constant at 5-10° C. This process took about 1 h, depending on the reaction volume, and the total amount of KMnO₄ was set to 133 mg/mL sulfuric acid. At this stage, the functionalizing molecule (bearing the desired functional groups) was added slowly to the system in excess (˜30 wt % in relation to the graphene added) (Step 4, FIG. 5), and the formation of radicals took place (e.g., ·OR, ·NR and ·SR), but reactivity of the radicals was kept low due to the low temperature. Then, the temperature was increased to 22° C. for 20-60 min (depending on the reactivity of the molecule applied (Step 5, FIG. 5), and once again cooled down to 5° C.

After the reaction, the resulting suspension was kept at 5° C., diluted (2 ml of H₂O per 1 mL of sulfuric acid), quenched with a 35% H₂O₂ solution (0.06 ml H₂O₂ per 1 mL 5% KMnO₄), and left stirring for 2 h. Then, the resulting suspension was transferred to a separation funnel and left overnight to precipitate. The precipitated slurry was separated and cleaned with 2 cycles of washing using 10% HCl (7 mL of HCl per 1 mL sulfuric acid). For applications demanding higher purity, the washed slurry was dialyzed (10 kDa molecular weight membrane) until stable pH.

Most of the reactant ratios are kept the same as in the water-based process of Example 1, except for the addition of a smaller amount of water to react with KMnO₄ (to minimise water interference in the reaction mechanism (Step 2 of FIG. 5), addition of KMnO₄ as a solid powder (Step 3 of FIG. 5), and the replacement of part of the water (Step 4 of FIG. 5) for another molecule that can easily bear relatively stable radical species (Step 4 of FIG. 5), preferentially a difunctionalized molecule. Moreover, the maximum concentration comported by this process is slightly lower than for the water-based process of Example 1, also due to viscosity restrictions imposed by the reduced amount of water added, and may be directly dependent on the viscosity contribution of the molecule used for functionalization.

### Example 3—Preparation of Highly Ordered Films

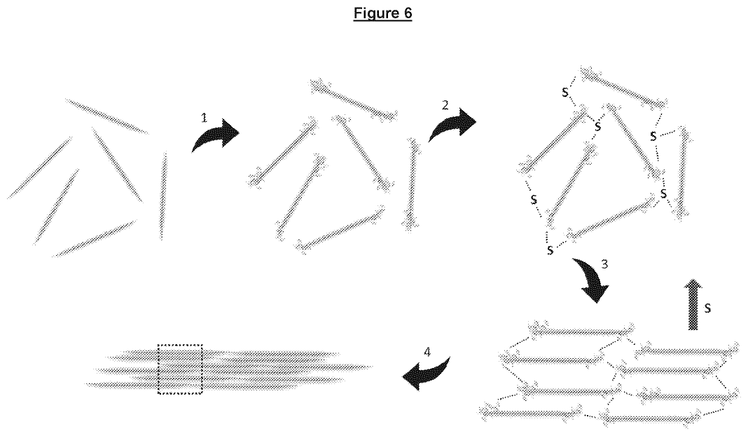

A schematic representation of the method to obtain a highly ordered film is shown in FIG. 6.

To demonstrate the processability and film formation properties of the functionalized graphene obtained in Example 1 (hereinafter referred to as “G_{stw}”), G_{sfw} was redispersed in a water:isopropanol mixture (1:1 volume ratio) and submitted to bath ultrasound (300 W) for 30 min. The resulting dispersion was centrifuged at 3000 rpm for 15 min, followed by another centrifugation at 6000 rpm for 15 min, to remove any aggregates that could disturb the film formation. The resulting supernatant was a very homogenous black dispersion presenting a liquid crystalline appearance. The organization of the dispersion seemed to be strongly assisted by the interaction between the functionalized regions of G_{sfw} (especially the edges) and the solvents applied. Although G_{sfw} is stable also in pure water, water:isopropanol mixtures produced more ordered and stable dispersions. Further, the supernatant was applied for film formation via direct solvent casting on a Teflon mold and via vacuum filtration using a polytetrafluoroethylene (PTFE) filtration membrane (0.2-1 μm pore sizes, depending on the lateral size of the source graphene used). During both filtration and solvent casting process, the removal of the solvent from the dispersion forced the interaction among the G_{sfw} functionalities in close vicinity, increasing the organization and allowing a highly ordered deposition of the G_{sfw} sheets (FIG. 6, steps 3 and 4).

The association between the controlled functionalization and the appropriate solvent mixture reinforced the already anisotropic nature of the 2D material-based dispersion, facilitating the self-assembly during film formation. The result obtained was highly ordered black/silver coloured films with very smooth surfaces (roughness in the nanoscale range). The film was very well oriented in-plane with a dense cross-section profile, and yields sturdy free-standing films with cross-sections as thin as 4 μm. These very ordered and dense films were obtained by direct casting/filtration at room temperature, without any further treatment involving pressure, thermal or chemical modifications. The films may be formed from a variety of Gsfw concentration, allowing ordered film formation with concentrations as high as 10 mg/mL. However, the most concentrated samples, due to the high initial viscosity, presented increased surface roughness. According to a particular embodiment, the concentration for the film formation without sacrificing structural order and surface smoothness may be ≤4 mg of G_{sfw} per mL of water/isopropanol mixture. This also reinforced the conclusion that the highly structural order of the films was a direct result of the material's anisotropy and solvent interaction from the initial film formation stages, suggesting lower initial entropy and consequently lower energy demand for the creation of highly ordered films.

Moreover, when the films formed were submitted to a simultaneous TGA and differential scanning calorimetry (DSC) analysis, they presented a defined exothermic transformation with an enthalpy of 111 J/g at 197° C., associated to a 3 wt % loss at the same temperature. This enthalpy was likely to be related to the condensation reaction among the functional groups, mostly composed by carboxyl and hydroxyl groups, that could react forming ether, ester and anhydride bridges among the sheets. The mass loss observed by TGA was directly associated to the evaporation of the water produced by these reactions (Eq. 1-3).

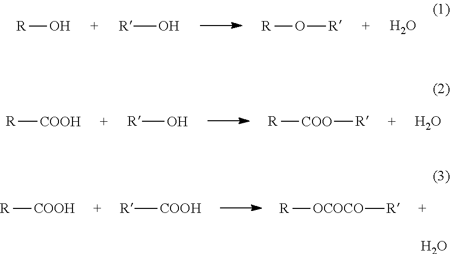

The reactions mentioned above allowed further structuration and the partial crosslinking of the film structure, allowing the reinforcement of the films in a much milder temperature than the graphitization processes, and avoided temperature related limitations to their applications.

### Example 4—Preparation of Conductive Films on Complex Surfaces and Confined Spaces

Since using the synthesis platform does not demand harsh post-treatments to the films or structures formed, it opens up a broad range of applications for the coating of complex structured surfaces that can be used in many different industries, from electronics to photonics. In this context, the G_{sfw} was applied to a Si (coated with SiO₂) surface with a micropillars array with 50×50 pillars within a 100 mm² area (pillars with 100 μm diameter and 100 μm height).

For the film formation onto the micropillar texturized substrate, 250 μL of a 4 mg/ml G_{sfw} dispersion in water/isopropanol (1:1 ratio) was casted onto it, forming a stable droplet. The droplet was left to evaporate (about 30 min) within a fume cupboard with constant air flow, producing a 1 mg film (˜10 μm thickness). Without any further treatment (nor drying), the substrate was submitted to Raman spectroscopy, atomic force microscopy (AFM) and SEM.

A very uniform coating of G_{sfw} was achieved, forming a very tight adhesion to the pillars with no noticeable interface gap, and a very smooth film surface (surface roughness=10-15 nm). Moreover, the film was evenly formed throughout the substrate, with the whole surface homogeneously covered by high quality graphitic film.

To demonstrate the good adhesion of the formed film onto the pillar array and in order to show that it could be further processed, the same G_{sfw} coated array was submitted to a new deposition layer of SiO₂, confining the G_{sfw} film within a dielectric/conductive/dielectric layered conformation. The SEM image revealed the different sections of the partially deposited array, as a function of their different electron density at the uppermost layer. However, the different elemental compositions of the sections could only be clearly detected when performing SEM-EDX and forming the integrated and segregated C, O and Si elemental maps. The elemental maps revealed the C rich surface at one section (G_{sfw}/SiO₂) and the Si and O richer surface of the other section (SiO₂/G_{sfw}/SiO₂), proving the effectiveness of associating the formed film casting with deposition methods to form complex layered structures.

The thermal and electrical properties of the films were also characterised. The thermal characterization was performed with a Light Flash Analyzer (LFA) setup, measuring the thermal diffusivity of the films with thicknesses ranging from few μms to few mms. This flash analysis method, which involved the application of energy at the bottom and subsequent detection at the top side, is best suited to measure thermal diffusivity values of up to 2000 mm²/s, giving rise to thermal conductivity values above 1000 W/mK. With the aid of a carefully designed mask and heat simulation models, both in-plane and out-of-plane values were obtained for a single film.

For the electrical characterization, the measurements were performed with a 4-probe sheet resistance setup (for in-plane) and a self-fabricated heterostructure stacked device (out-of-plane). The former method, which consisted of 4 equally spaced probes (two outer probes for the application of measurement current, two inner probes for voltage drop measurement), is widely used to measure sheet resistance of thin films with thicknesses less than 40% of the spacing between the probes (1 mm). Finally, for the out-of-plane measurements, a 4-probe device was designed. In this case, the device was made with metal electrodes (Cr 5 nm/Au 60 nm) deposited on the bottom and top, sandwiching the film.

The films obtained, although not using any post-processing, presented values of in-plane thermal conductivity from 10 to 120 W/mK. The out-of-plane thermal conductivities were of the order of 0.05-0.2 W/mK. Hence, the formed films have high anisotropy rations (˜850), a value only attainable for 2D materials synthesized and engineered using expensive methods such as chemical vapour deposition (CVD).

Regarding the electric conductivity, the films presented sheet resistances as low as 30 mOhm/sq, with the in-plane conductivity reaching values above 100 kS/m, yielding values that were competitive to other carbon films which are non-processable and obtained via high temperature/pressure processes. However, very differently from most other commercial carbon films, the film formed in the present example had anisotropic electric properties, with through-plane conductivities even below 1 S/m, producing anisotropy ratios as high as ρ=100,000, consequently forming films that can be in-plane conductors and out-of-plane insulators.

Whilst the foregoing description has described exemplary embodiments, it will be understood by those skilled in the technology concerned that many variations may be made without departing from the present invention.

1. A method of forming an edge-functionalised 2D material, the method comprising:
mixing a 2D material with a solvent at a first pre-determined temperature to form a dispersion;
adding an oxidising agent and a multifunctional molecule to the dispersion;
adjusting the temperature to a second pre-determined temperature for a pre-determined period of time;
adjusting the temperature to a third pre-determined temperature; and
adding a quenching agent to form a suspension, wherein the suspension comprises the edge-functionalised 2D material.

2. The method according to claim 1, wherein the solvent is an oxidising acid.

3. The method according to claim 1, wherein the first pre-determined temperature is ≤10° C.

4. The method according to claim 1, wherein the mixing comprises mixing the solvent and the 2D material in a weight ratio of 8:1-28:1.

5. The method according to claim 1, wherein the adding an oxidising agent and a multifunctional molecule to the dispersion comprises adding the oxidising agent and multifunctional molecule sequentially.

6. The method according to claim 5, wherein the adding an oxidising agent and a multifunctional molecule to the dispersion comprises adding the oxidising agent to the dispersion followed by adding the multifunctional molecule after a period of time.

7. The method according to claim 6, wherein the period of time is 1-15 minutes.

8. The method according to claim 1, wherein the multifunctional molecule comprises a multifunctional alcohol, multifunctional amine, amino alcohol, thiol, or a mixture thereof.

9. The method according to claim 1, wherein the second pre-determined temperature is ≤25° C.

10. The method according to claim 1, wherein the pre-determined period of time is ≤60 minutes.

11. The method according to claim 1, wherein the third pre-determined temperature is ≤10° C.

12. The method according to claim 1, wherein the quenching agent is a reducing agent for quenching oxidation and functionalisation of the 2D material.

13. The method according to claim 1, wherein the method further comprises separating a precipitate from a suspension formed following the adding a quenching agent, wherein the precipitate comprises the edge-functionalised 2D material.

14. The method according to claim 1, wherein the formed edge-functionalised 2D material is further formed into a film.
